(19) United States
(12) Patent Application Publication
(10) Pub. No.: US 2009/0040239 A1
(43) Pub. Date: Feb. 12, 2009

(54) Graphic object translation system

(76) Inventors: David N. Skinner, Cupertino, CA (US); Yancy Chen, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/890,820

(22) Filed: Aug. 7, 2007

(51) Int. Cl. G09G 5/00

(52) U.S. Cl. 345/684

(57) ABSTRACT

A graphic object translation system is described. The graphic object translation system has an automatically retracting arcuate control component that has a rest position to which it returns after being moved and released. The graphic object translation system also has a graphic control component that is responsive to a movement of the arcuate control component and causes a graphic object to be graphically translated from its existing position.

### TECHNICAL FIELD

The present invention relates to a graphic object translation system.

### BACKGROUND

Computer scrolling systems that include components such as scroll wheels can be provided with computer systems so as to be employed by computer users when using their computers. As suggested, scroll wheels can be employed for scrolling purposes. It should be appreciated that these devices provide a convenient way to control the movement of content that is being displayed on a computer screen.

With reference now to FIGS. 1 and 2, exemplary prior art devices are shown. FIG. 1 depicts a block diagram of a mouse 100 that includes a scroll wheel 150. Because scroll wheel 150 is able to rotate, the use of scroll wheel 150 provides a rotary feel to a user.

FIG. 2 is a block diagram that shows the diameter of a conventional scroll wheel 201 in relation to the thickness of the computer component of which it is a part. As illustrated in FIG. 2, the conventional scroll wheel (e.g., wheel 201) forms a complete circle. The housing 202 of the scroll wheel 201 can be a part of a computer component, such as, but not limited to: a mouse (e.g., FIG. 1), a touch pad, and/or a keyboard.

In response to the market's growing demand for small, portable computers and/or pointing devices, some manufacturers of these small, portable computers have replaced the traditional scroll wheel with other forms of pointing devices which allow for scrolling, such as a touchpad. Nevertheless, these solutions often do not provide the users of the portable computer and/or pointing device with the much desired rotary tactile feedback.

### SUMMARY

A graphic object translation system is described. The graphic object translation system has an automatically retracting arcuate control component that has a rest position to which it returns after being moved and released. The graphic object translation system also has a graphic control component that is responsive to a movement of the arcuate control component that causes a graphic object to be graphically translated from its existing position.

### BRIEF DESCRIPTION OF THE DRAWINGS

FIG. 1 shows a block diagram of a conventional mouse with a scroll wheel.

FIG. 2 shows a block diagram shows the diameter of a conventional scroll wheel in relation to the thickness of a conventional pointer device.

FIG. 3 shows a block diagram of a scrolling device according to one embodiment of the invention.

FIG. 4 shows a block diagram of a graphic object translation system in operation according to one embodiment of the present invention.

FIG. 5 shows a block diagram illustrating the arc defining the arcuate control component of the graphic object translation system and ratio of the diameter of the circle defined by that arc to the arcuate control component housing according to one embodiment of the present invention.

FIG. 6 shows a block diagram of a scrolling device that is part of a touch pad according to one embodiment of the present invention.

FIG. 7 shows a block diagram of a scrolling device that is part of a touch pad of an arcuate control component that is dome shaped according to one embodiment of the present invention.

FIG. 8 shows a block diagram of a scrolling device that is part of a keyboard and of an arcuate control component that is wheel shaped according to one embodiment of the present invention.

FIG. 9 shows a flow chart of steps performed in a method of causing graphic object translation according to one embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which can be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention can be practiced without these specific details. In other instances, well known methods, procedures, components, and circuits have not been described in detail as not to unnecessarily obscure aspects of the invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “setting,” “storing,” “scanning,” “receiving,” “sending,” “disregarding,” “entering,” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

In overview, embodiments of the present claimed subject matter provide methods and systems for graphic object translation. In one embodiment, a graphic object translation system has an arcuate control component that acts much like a joystick, in that it has a rest position to which it returns after being moved, and a graphic control component that responds to the movement of the arcuate control component by causing the graphic object, such as a pointer on a computer screen, to change positions. Partially because the arcuate control component is bowed and/or rounded, it may provide a user with a similar rotary and/or wheel feel as is provided by prior art scroll wheels.

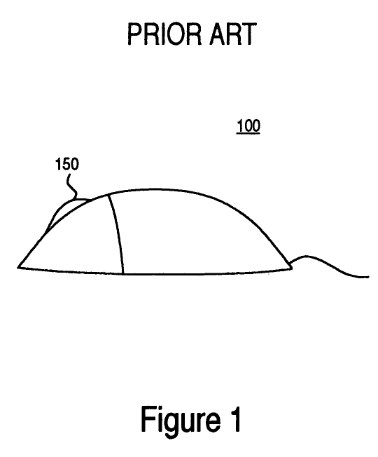

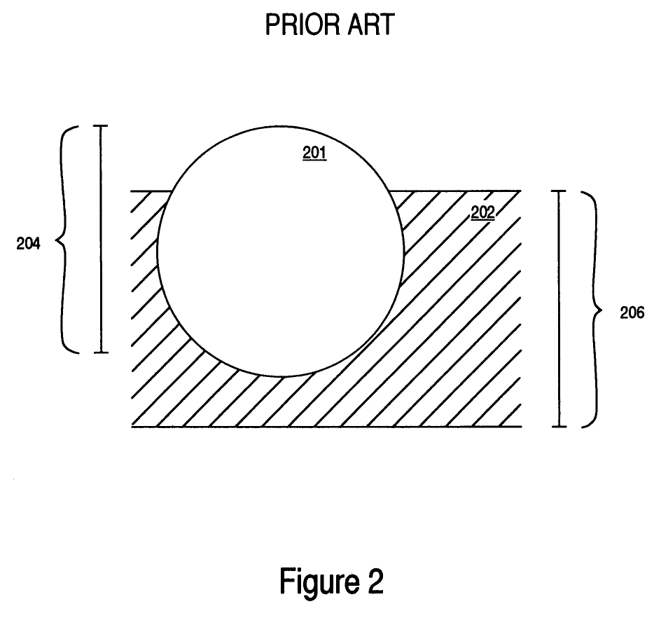

In some instances, embodiments also include an arcuate control component which is defined by an arc with a diameter greater than the thickness of the housing supporting the arcuate control component. Moreover, because the arcuate control component can be shaped generally as a partial circle instead of a full circle, less housing and/or mounting space may be required to utilize the graphic object translation system. This means that in such embodiments, the graphic object translation system may be used in a pointer device (e.g., mouse) or other component that is thinner than is conventionally provided (See FIGS. 1 and 2). It should be appreciated that in one embodiment, the graphic object translation system may include a scrolling device with a half-wheel shaped body which pivots about a point.

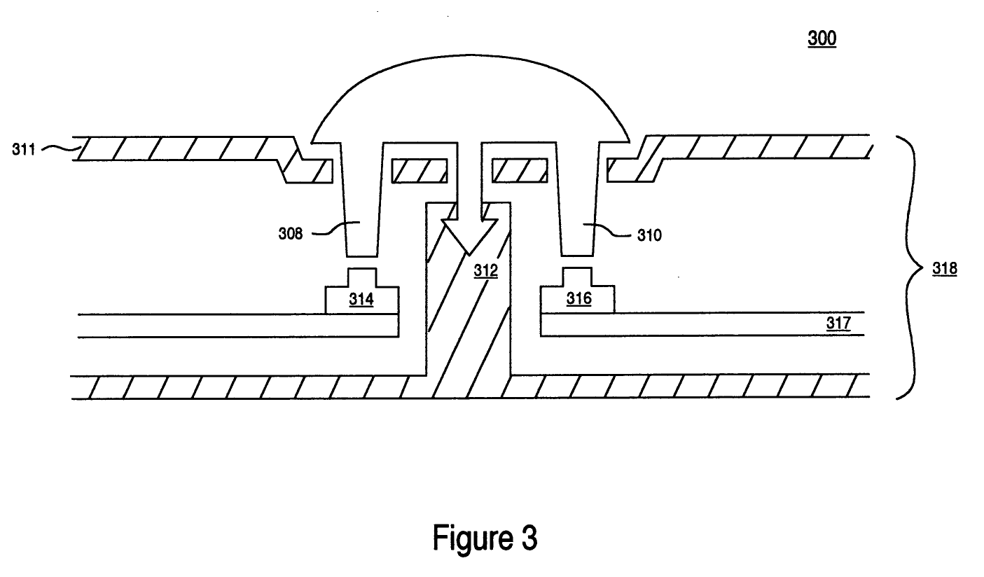

FIG. 3 shows a block diagram of an exemplary scrolling device 300 and an exemplary housing of the scrolling device (also referred to as a graphic object translation device), in accordance with one embodiment of the present invention. FIG. 3 shows a scrolling device, mounted in a housing with two switch activation elements (e.g., 308 and 310) capable of activating two switches (e.g., 314 and 316). In other embodiments, a different number of switch activation elements and switches may be used. Referring to FIG. 3, housing 318 includes mounting surface 311, entrapment component 311 and printed circuit board (PCB) 317. Although FIG. 3 is shown and described as having certain numbers and types of elements, exemplary embodiments are not so limited; that is, other embodiments may include elements other than the ones shown, and may also include more than one of the elements that are shown.

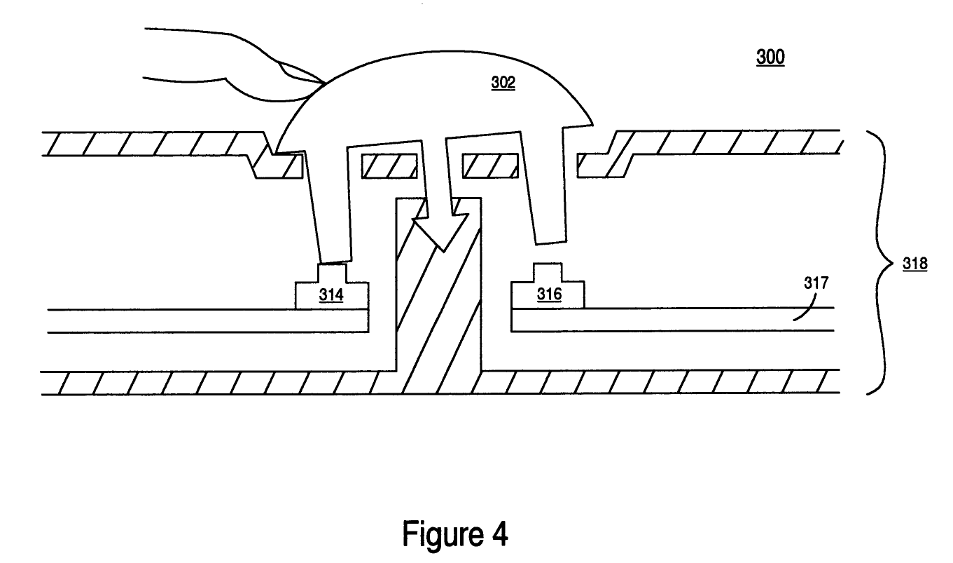

FIG. 4 shows an exemplary graphic object translation system (such as the one shown in FIG. 3) in operation, in accordance with one embodiment of the present invention. Referring to FIG. 4, in one embodiment, an automatically retracting arcuate control component 302 and a graphic control component 404 are housed in housing 318. In one embodiment, when force is applied to the arcuate control component 302 at an angle that is not directly downward, the arcuate control component activates a graphic control component (e.g., 314) on a printed circuit board (e.g., PCB 317). In one embodiment, this causes a translational movement of a pointer on a computer screen. In one embodiment, when force is applied directly downward on the arcuate control component 302 both graphic control components 314 and 316 (also referred to as switches) may be activated. In one embodiment, a mouse click may occur when force is applied downward on the arcuate control component 302. In other embodiments a mouse click may not occur when force is applied downward on the arcuate control component 302. In one embodiment, when force is applied to the arcuate control component 302 at an angle that is not directly downward, scrolling in a particular direction associated with that angle occurs. Also, in one embodiment, the amount of force that is applied to the arcuate control component 302 at an angle may be related to the scrolling speed. For example, greater force applied to the arcuate control component may cause a relatively faster scrolling speed, while lighter force applied to the arcuate control component may cause a relatively slower scrolling speed. Although FIG. 4 is shown and described as having certain numbers and types of elements, exemplary embodiments are not so limited; that is, other embodiments may include elements other than the ones shown, and may also include different numbers of the elements than are shown.

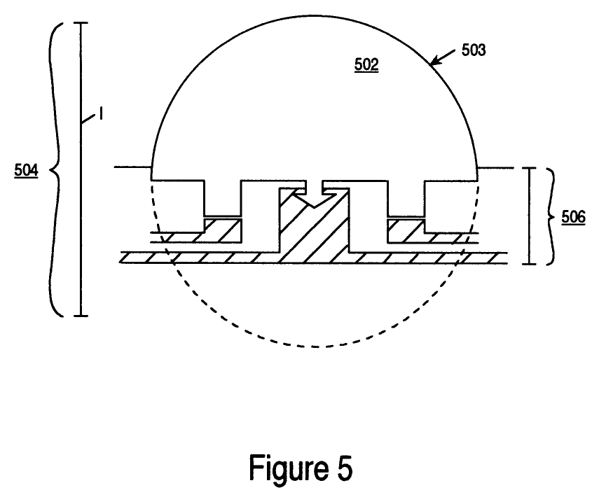

FIG. 5 shows a block diagram that illustrates an exemplary arcuate control component diameter to housing length ratio in accordance with one embodiment. In the FIG. 5 embodiment, arcuate control component 502 has a surface that is defined by arc 503. Referring to FIG. 5, the diameter of an imaginary scroll wheel that is coaxial with arcuate control component 502, and the length of an exemplary housing of arcuate control component 502 are labeled as 504 and 506, respectively. As previously discussed, arcuate control component 502 has a body defined by arc 503. It should be appreciated that arc 503 and the dotted lines of a complimentary arc combine to circumscribe the aforementioned imaginary scroll wheel that has diameter 504. As depicted, in one embodiment, the diameter 504 of the imaginary scroll wheel is much greater than the thickness of the housing device 506.

Referring again to FIG. 5, in one embodiment, because the body of arcuate control component 502 does not form a complete circle, the body of the arcuate control component may be used on a relatively thin pointing device, such as, but not limited to a thin keyboard, a thin touch pad, and a thin mouse. However, in one embodiment, the arcuate control component 502 may be shaped to convey a sense of rotary motion provided by an actual scroll wheel having dimensions equivalent to those possessed by the imaginary scroll wheel. Although, FIG. 5 is shown and described as having certain numbers and types of elements, exemplary embodiments are not so limited; that is, other embodiments may include elements other than the ones shown, and may also include different numbers of the elements that are shown.

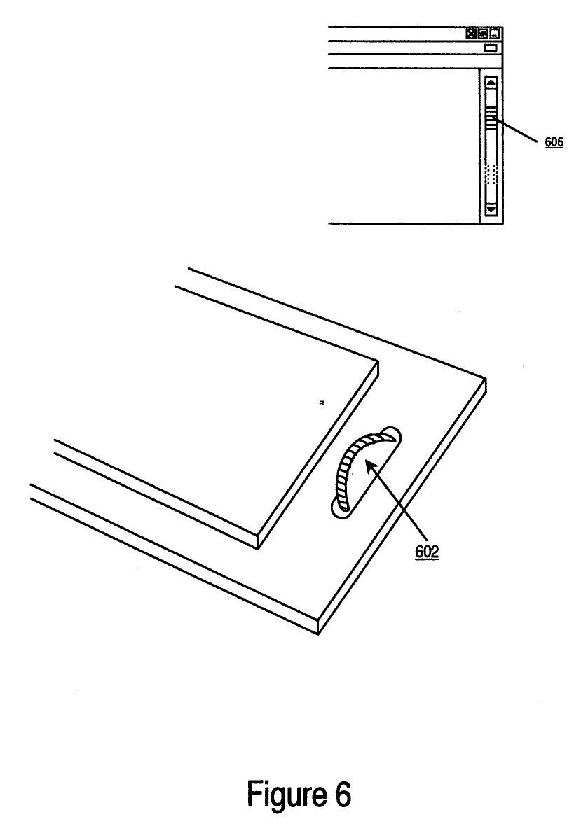

FIG. 6 shows a block diagram of an arcuate control component that is a part of a touch pad according to one embodiment of the present invention. Referring to FIG. 6, an arcuate control component 602 provided in conjunction with a touch pad, and a scroll bar 606 (that is responsive to movements of the arcuate control component 602) is depicted. As shown in FIG. 6, in one embodiment, the surface of the arcuate control component 602 may be patterned so as to provide friction between the fingertip of a user and the arcuate control component. In one embodiment, arcuate control component 602 may have textured lines and/or grooves on a portion of, or on the whole surface of its body.

Referring still to FIG. 6, when the arcuate control component 602 is in operation, force or pressure applied to the arcuate control component 602 causes a scrolling movement (as is depicted) of scroll bar 606. In another embodiment, the arcuate control component 602 can cause the movement of a pointer instead of a scrolling movement. Although FIG. 6 is shown and described as having certain numbers and types of elements, embodiments are not so limited; that is, other embodiments may include elements other than the ones shown, and may also include a different numbers of the elements that are shown.

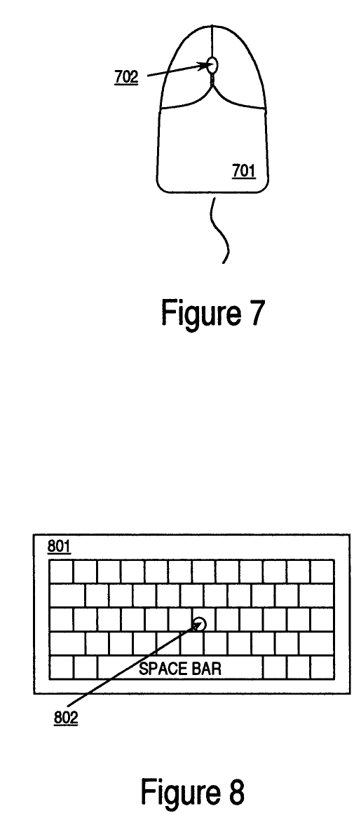

FIG. 7 shows a mouse 701 that includes an arcuate control component 702 according to one embodiment. In one embodiment, arcuate control component 702 may be made of an elastomeric material, which may be shaped to provide a rotary and/or wheel feel and designed to provide friction between the finger of a user and the arcuate control component 702. In other embodiments, other material may be used to fabricate arcuate control component 702. Arcuate control component 702 may also be shaped in various ways. For example, the body of the arcuate control component may be dome shaped, or the body may be shaped like a half-wheel, etc. As discussed herein, in operation, the arcuate control component may be pressed downward to correspond to a mouse click, pressed and/or pushed to cause scrolling movement, or pressed in various directions to cause pointer movement.

Additionally, as discussed herein, arcuate control component 702 may include several switch activation elements, which when used to activate one or more graphic control component(s) may correspond to one or more movement(s) of a pointer in one or more direction(s). For example, in one embodiment, a graphic object translation system may have four switch activation elements (scroll control components) for activating four graphic control components corresponding to four different directions of movements of a pointer. Moreover, in such an embodiment, more than one graphic control component may be activated at a time to move the pointer in a direction that is a combination of the individual directions that correspond to the individual graphic control component activated. Although FIG. 7 is shown and described as having certain numbers and types of elements, exemplary embodiments are not so limited; that is, other embodiments may include elements other than the ones shown, and may also include different numbers of the elements that are shown.

FIG. 8 illustrates an exemplary embodiment of an arcuate control component 802 that is part of a keyboard 801. As discussed above, arcuate control component 802 can be used to control a scrolling motion and/or various pointer motions. In one embodiment, as discussed herein the arcuate control component 802 may be coupled to switch activation elements for controlling a plurality of graphic control components simultaneously. Furthermore, in one embodiment, when a plurality of graphic control components are simultaneously activated, a signal for a mouse click may occur.

Furthermore, still referring to FIG. 8, as discussed herein arcuate control component 802 may include components formed from an elastomeric material. A mounting component made of elastomeric material may help to provide a sense of rotary and/or wheel motion to a user. Although FIG. 8 is shown and described as having certain numbers and types of elements, embodiments are not so limited; that is, other embodiments may include elements other than the ones shown, and may also include different numbers of the elements that are shown.

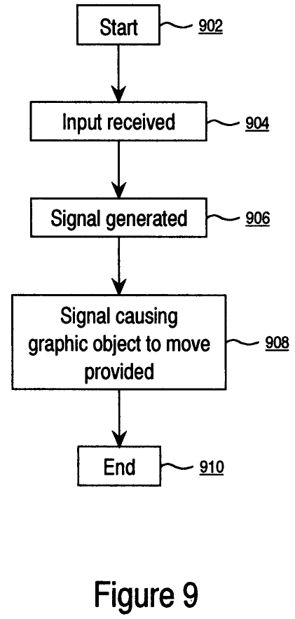

Referring now to FIG. 9, a flowchart of steps performed in a method for causing graphic object translation is depicted.

At block 902, the process starts.

At block 904, input provided via an arcuate control component is received. The arcuate control component may be defined by an arc that is a portion of a circle that in one embodiment has a diameter greater than the thickness of the housing of the arcuate control component. In one embodiment, because the arcuate control component of the graphic object translation system is shaped as a partial wheel instead of a full wheel, the graphic object translation system may be used in a pointer device that is thinner than the traditional pointer devices used by prior art scroll wheels while still providing a rotary feel to a user.

At block 906, a signal based on the input received in step 904 is generated. In one embodiment, this signal corresponds to a movement of a graphic object from an initial position to a second position.

At block 908, the signal is provided to screen/and or curser control components of a computer program (e.g., operating system) that executes on an associated computer, which causes a graphic object to move from an initial position to a second position. In one embodiment, a movement of a graphic object corresponds to the movement of a pointer on a computer screen from an initial position to a second position. In another embodiment, a movement of a graphic object corresponds to the scrolling of a page.

At block 910, the process ends. Although FIG. 9 is shown and described as having certain numbers and types of elements, the present claimed subject matter is not so limited; that is, other embodiments may include elements other than the ones shown, and may also include more than one of the elements that are shown

In the foregoing specification, embodiments have been described with reference to numerous specific details that may vary from implementation to implementation. Thus, the sole and exclusive indicator of what is, and is intended by the applicants to be the claimed subject matter is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A graphic object translation system on a computer mouse, comprising:
an automatically retracting arcuate control component that has a rest position to which said arcuate control component returns after being moved and released; and
a graphic control component responsive to a movement of said arcuate control component that causes a graphic object to be graphically translated from its existing position.

2. The graphic object translation system of claim 1, wherein a downward motion of said arcuate control component causes a mouse click.

3. The graphic object translation system of claim 1, wherein said arcuate control component is made at least in part of an elastomeric material.

4. The graphic object translation system of claim 1, wherein a surface of said arcuate control component is patterned to provide a user surface friction.

5. The graphic object translation system of claim 1, wherein said arcuate control component is dome shaped.

6. The graphic object translation system of claim 1, wherein said arcuate control component is half wheel shaped.

7. A method for causing graphic object translation comprising:
receiving an input generated by an arcuate control component that has a rest position to which said arcuate control component returns after being moved and released, wherein said arcuate control component is mounted in a housing, and wherein said arcuate control component is defined by an arc that is a portion of a circle that has a diameter greater than the thickness of said housing;
generating a signal based on said input that corresponds to a movement of a graphic object from an initial position of said graphic object to a second position of said graphic object; and
providing access to said signal for control of said graphic object.

8. The method of claim 7, wherein said movement of said graphic object from an initial position to a second position includes scrolling of said graphic object.

9. The method of claim 7, wherein said arcuate control component is made at least in part of an elastomeric material.

10. The method of claim 7, wherein a surface of said arcuate control component is patterned to provide a user surface friction.

11. The method of claim 7, wherein said housing is part of a keyboard.

12. The method of claim 7, wherein said housing is part of a mouse.

13. The method of claim 7, wherein said housing is part of a touchpad.

14. A scrolling device comprising:
a plurality of scroll control components, wherein activation of one or more of said scroll control components causes scrolling in a particular direction; and
a body coupled with said plurality of scroll control components comprising a first portion that is arcuate on one side of a mounting surface of a housing and a second portion that lies on a second side of said mounting surface of said housing, wherein said scrolling in a particular direction is responsive to a movement and release of said body.

15. The scrolling device of claim 14, wherein a mouse click occurs when downward pressure is applied to more than one of said plurality of scroll control components simultaneously.

16. The scrolling device of claim 14, wherein an increase in pressure applied by a user to said scrolling device causes an increase in speed of said scrolling.

17. The scrolling device of claim 14, wherein a surface of said first portion is patterned to provide a user surface friction.

18. The scrolling device of claim 14, wherein said scrolling device is a part of a keyboard.

19. The scrolling device of claim 14, wherein said scrolling device is a part of a touchpad.

20. The scrolling device of claim 14, wherein said scrolling device is a part of a mouse.
